(19) United States
(12) Patent Application Publication
(10) Pub. No.: US 2005/0211039 A1
(43) Pub. Date: Sep. 29, 2005

(54) Saw blade guard having illuminator

(75) Inventors: Eric Lo, Taichung (TW); George Ku, Taichung (TW)

Correspondence Address: BACON & THOMAS, PLLC, 625 SLATERS LANE, FOURTH FLOOR, ALEXANDRIA, VA, 22314, US

(73) Assignee: Rexon Industrial Corp., Ltd., Taichung (TW)

(21) Appl. No.: 10/851,056

(22) Filed: May 24, 2004

(30) Foreign Application Priority Data
Mar. 23, 2004 (TW) 93204427

(51) Int. Cl. B23D 45/06

(52) U.S. Cl. 83/477.2; 83/520

(57) ABSTRACT

A saw blade guard for use in a sawing machine includes a main body having inside a receiving space and an opening communicating with the receiving space, a control panel mounted on the main body, an illuminator mounted on the main body and protruding into the receiving space of the main body, a battery pack mounted in the control panel, and a switchgear mounted on the control panel and electrically connected with the illuminator and the battery pack for controlling the illuminator for illumination.

### BACKGROUND OF THE INVENTION

1. Field of the Invention

The present invention relates generally to saw blade guards of sawing machines, and more particularly to a saw blade guard having an illuminator.

2. Description of the Related Art

A common table saw is comprised of a base, a worktable mounted on the base, a circular saw blade, and a saw blade guard. The saw blade is rotatably mounted to the base for stationary rotation, having its partial outer peripheral edge protruding retractably upwards and downwards out and over a top surface of the worktable. The saw blade guard is hooded over and around the protruded part of the saw blade for preventing the user from harm caused by accidentally touching the saw blade exposed outside, and can be uncovered by an external force. When the user intends to do the sawing in the dim environment, it is safer for working to enhance the lighting in the working environment or to install an additional lighting device over the worktable. When the lighting device is installed over the worktable, the lighting device projects the light towards the saw blade guard, such that the area around the saw blade is under the light to become brighter. However, the light projected from the lighting device is partially projected on the external area around the saw blade guard to generate shadow at the internal area or on a workpiece. Hence, when the user operates the saw blade to cut the workpiece, it is not easy for the user to precisely recognize where to cut.

### SUMMARY OF THE INVENTION

The primary objective of the present invention is to provide a saw blade guard having an illuminator; the saw blade guard provides preferable lighting effect for a sawing machine to enhance preferably accurate sawing.

The foregoing objective of the present invention is attained by the saw blade guard for use in the sawing machine. The saw blade guard is comprised of a main body having inside a receiving space and an opening communicating with the receiving space, a control panel mounted on the main body, an illuminator mounted on the main body and protruding into the receiving space of the main body, a battery pack mounted in said control panel, and a switchgear mounted on the control panel and electrically connected with the illuminator and the battery pack for controlling the illuminator for illumination.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a partial sectional view of the preferred embodiment of the present invention; and

FIG. 4 is a schematic view of the preferred embodiment of the present invention mounted on a sawing machine.

### DETAILED DESCRIPTION OF PREFERRED EMBODIMENTS

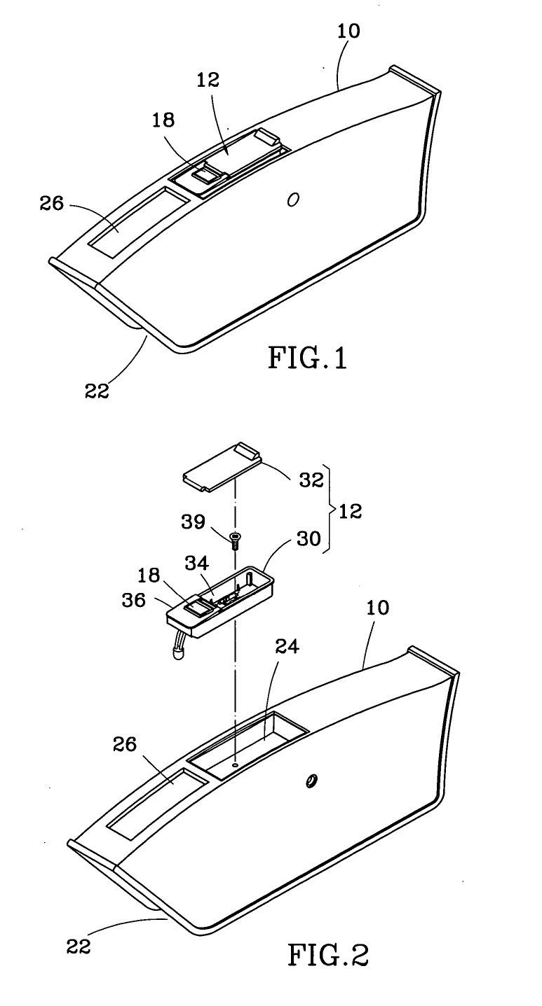

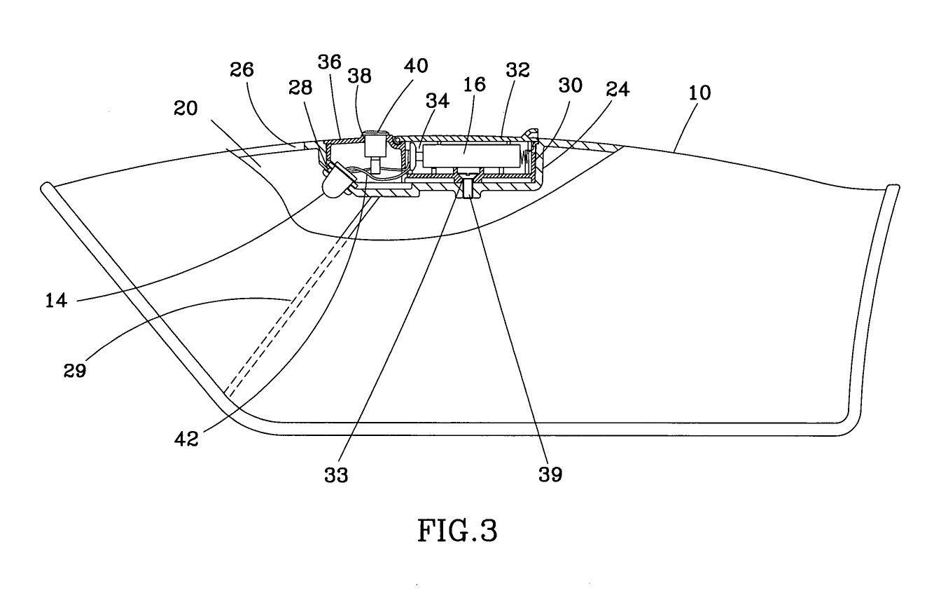

Referring to FIGS. 1-3, a saw blade guard constructed according to a preferred embodiment of the present invention for a sawing machine is comprised of a main body 10, a control panel 12, an illuminator 14, a battery pack 16, and a switchgear 18.

The main body 10 is an elongated U-shaped shell, having inside a receiving space 20 extending along a long axle thereof and longitudinally running through the main body 10. An opening 22 is formed at a bottom side of the main body 10 and communicates with the receiving space 20 to enable the bottom side of the main body 10 to be open. The main body 10 is provided with a locating portion 24 formed on a top side thereof and recessed towards the receiving space 20, and a window 26 disposed on the top side thereof and communicated with the receiving space 20. The locating portion 24 has a through hole 28 running through a front sidewall thereof. A guard plate 29 extends from a bottom end of the front side wall of the locating portion towards the opening 22 for preventing the user's hands from accidentally touching a saw blade of the sawing machine.

The control panel 12 includes an elongated battery holder 30 and a top cover 32. The battery holder 30 has a compartment 34 recessed downwards from a top side thereof to enable the battery holder 30 to have a top open, and a fixing portion 36 extending forwards at a front end thereof and having a fixing hole 38 running therethrough. The top cover 32 is mounted over the compartment 34, having a front end pivoted to the battery holder 30 for pivotal movement with respect to the battery holder 30, whereby the top cover 32 is pivotally covered on the battery holder 30. The control panel 12 is mounted in and fixedly interconnected with the locating portion 24 of the main body 10 by a screw 39 threadedly inserted into a screw hole 33 formed at a bottom side of the battery holder 30, such that the fixing portion 36 faces the front side of the main body 10 and a top side of the top cover 32 is substantially flush with a top side of the main body 10.

The illuminator 14, which is embodied as an LED bulb or can be any other alternative bulb, is mounted to the through hole 28 of the locating portion 24 of the main body 10, having a front end protruding into the receiving space 20 and facing the open bottom side of the main body 10.

The battery pack 16 is embodied as two 1.5V alkali batteries mounted in the compartment 34 of the battery holder 30.

The switchgear 18 includes a changeover switch 40 and a plurality of lead wires 42. The changeover switch 40 is mounted in the fixing hole 38 of the control panel 12. The lead wires 42 are disposed under the fixing portion 36 and respectively electrically connected with the changeover switch 40, the illuminator 14, and the battery pack 16, such that the changeover switch 40 can control whether the illuminator 14 will illuminate or not.

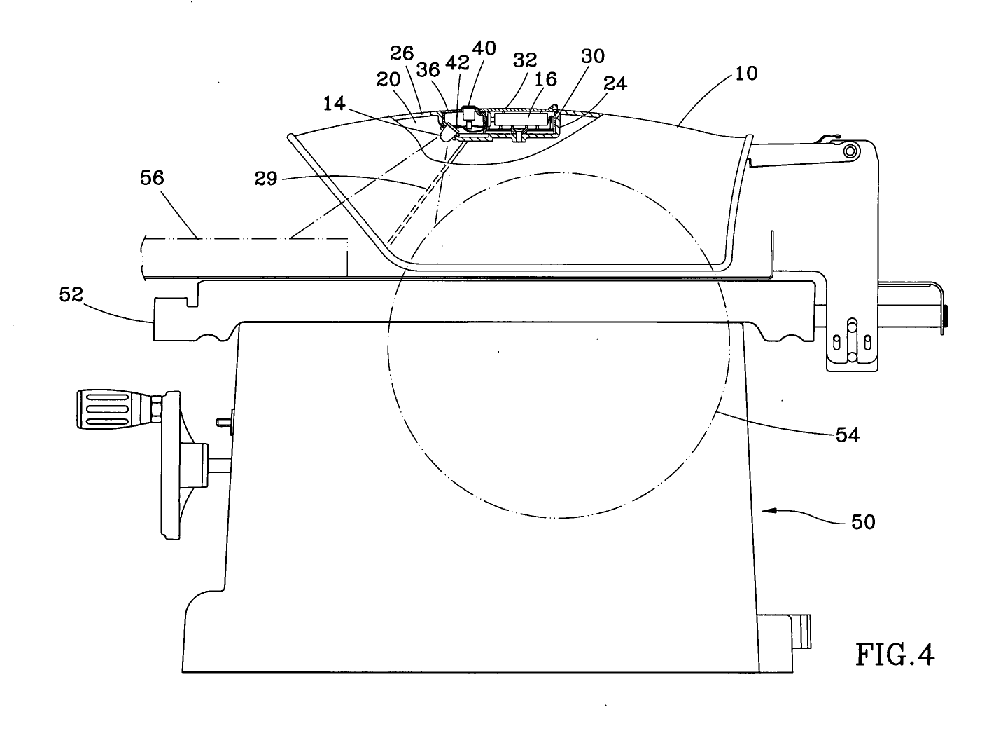

Referring to FIG. 4, the main body 10 is mounted on a circular sawing machine 50, which includes a worktable 52 and a circular saw blade 54 (indicated by an endless dotted line) protruding upwards partially out the worktable 52, and is pivotally mounted over the worktable 52 such that the main body 10 can pivot over the worktable 52. The main body 10 is hooded over and around the saw blade 54 to enable the saw blade 54 to be inserted through the opening 22 and into the receiving space 20. When the user cuts a workpiece 56, a front end of the main body 10 and the control panel 12 are pushed against by the workpiece 56 to raise upwards along with the feeding of the workpiece 56. If the environment where the workpiece 56 is under sawing is dim or dark, the user will fail to recognize accurately where to cut when the user intends to cut the workpiece 56 by the saw blade 54. In the meantime, the user can operate the changeover switch 40 to turn on the illuminator 14 for illumination, and the light generated from the illuminator 14 is projected from an upper portion of the receiving space 20 towards the opening 22, as indicated by a straight dotted line, such that the saw blade 54 and the workpiece 56 are illuminated by the light to enable the user to accurately recognize where to cut for the workpiece 56 through the window 26.

Accordingly, the present invention provides preferably excellent illuminative effect to further cause preferable accurate sawing on any of workpieces in the dim or dark environment.

1. A saw blade guard for use in a sawing machine, said saw blade guard comprising:
a main body having inside a receiving space and an opening in communication with said receiving space;
a control panel mounted on said main body;
an illuminator mounted on said main body and protruding towards said opening of said receiving space of said main body and into said receiving space;
a battery pack mounted in said control panel; and
a switchgear electrically connected with said illuminator and said battery pack for controlling said illuminator for illumination.

2. The saw blade guard as defined in claim 1, wherein said main body comprises a locating portion recessed from a top side thereof towards said receiving space for receiving said control panel.

3. The saw blade guard as defined in claim 1, wherein said main body comprises a window formed on a top side thereof and communicated with said receiving space.

4. The saw blade guard as defined in claim 1, wherein said control panel comprises a battery holder and a top cover, said battery holder having a compartment recessed downwards from its top side, said top cover being pivotally mounted on said battery holder and over said compartment for pivotal movement with respect to said battery holder, said battery pack being mounted in said compartment.

5. The saw blade guard as defined in claim 4, wherein said battery holder comprises a fixing portion formed at a front end thereof and a fixing hole formed on said fixing portion; said switchgear is mounted to said fixing hole of said fixing portion.

6. The saw blade guard as defined in claim 1, wherein said switchgear is mounted to said control panel.
